(19) United States
(12) Patent Application Publication
(10) Pub. No.: US 2025/0303781 A1
(43) Pub. Date: Oct. 2, 2025

(54) Training Aid for Pre-Writing Skills

(71) Applicant: WiSys Technology Foundation, Inc., Madison, WI (US)

(72) Inventors: Madalyn Nicole Kawleski, Jefferson, WI (US); Sydney Marie Bruce, Madison, WI (US); Paul David Jacobson, Mazomanie, WI (US); Camerson Michael Uselding, Sheboygan Falls, WI (US); Harold Thomas Evensen, Verona, WI (US); Lindsey Kay Rowley, Marion, IA (US)

(21) Appl. No.: 19/091,265

(22) Filed: Mar. 26, 2025

Related U.S. Application Data
(60) Provisional application No. 63/569,992, filed on Mar. 26, 2024.

(51) Int. Cl. B43K 29/00; B43K 29/10; G09B 19/24

(52) U.S. Cl. CPC B43K 29/005; B43K 29/10; G09B 19/24

(57) ABSTRACT

A pre-writing training aid provides a writing utensil that can detect desired practice motions, for example, scribbling, to provide positive reinforcement through sound and lights.

### CROSS REFERENCE TO RELATED APPLICATION

This application claims the benefit of U.S. provisional application 63/569,922 filed Mar. 26, 2024 and hereby incorporated by reference in its entirety

### BACKGROUND OF THE INVENTION

The present invention relates to a method and apparatus for assisting children in developing pre-writing skills and, in particular, to a writing utensil providing measurement of writing skills and positive reinforcement for pre-writing development.

Children with developmental delays or impaired motor skills may find writing to be a slow and frustrating process that discourages them from the very activities needed to be improved. Such activity can be as simple as random scribbling or can include making loops, lines, or other primitive shapes.

### SUMMARY OF THE INVENTION

The present invention provides a writing utensil that can monitor movement and provide positive reinforcement to the user for a range of different movement types foundational for writing skill.

More specifically, the present invention provides a pre-writing training aid having a housing adapted to hold a writing utensil extending along an axis with a writing tip of the writing utensil exposed for writing. A set of sensors detecting motion of the writing tip on a writing surface in at least two dimensions and a user feedback output selected from at least one of a speaker and a lamp are also provided. A sensor circuit activates the user feedback output to provide positive reinforcement when motion detected by the sensors matches a predefined motion goal.

It is thus a feature of at least one embodiment of the invention to provide a simple drawing tool that can monitor and provide feedback with respect to predefined pre-writing activities.

The sensors may include orthogonally mounted accelerometers indicating motion of the writing utensil perpendicular to the axis and at least one writing tip pressure sensor indicating an axial pressure on the writing utensil.

It is thus a feature of at least one embodiment of the invention to provide fundamental measurements of writing activity in a self-contained device.

The sensor circuit may compensate for gravitational acceleration caused by a non-vertical extension of the writing utensil during writing.

It is thus a feature of at least one embodiment of the invention to permit the use of contactless accelerometers for monitoring writing motion with reduced error caused by gravitational acceleration.

The predefined motion goal may be any motion in two dimensions.

It is thus a feature of at least one embodiment of the invention to provide a very low threshold for positive feedback to a user showing multiple dimensions of writing movement.

Alternatively or in addition, the predefined motion goal may be loops within a two-dimensional plane.

It is thus a feature of at least one embodiment of the invention to monitor and provide useful feedback on a more sophisticated element of writing being the generation of loops.

Alternatively or in addition, the predefined motion goal may be constant motion along a line.

It is thus a feature of at least one embodiment of the invention to provide useful feedback on a more sophisticated element of writing being the generation of lines.

The pre-writing training aid may further include a clamp for releasably holding the writing utensil.

It is thus a feature of at least one embodiment of the invention to allow ready replacement of the actual writing utensil, for example, to provide variation in color, or tip-to-paper friction.

The outer surface of the housing is sized to be gripped by a user of the writing utensil during writing.

It is thus a feature of at least one embodiment of the invention to provide a writing/drawing experience permitting a gripping similar to that used with typical writing instruments.

The sensor circuit may activate the user feedback output to play music to provide positive reinforcement.

It is thus a feature of at least one embodiment of the invention to provide a varied and rewarding feedback experience through music.

These particular objects and advantages may apply to only some embodiments falling within the claims and thus do not define the scope of the invention.

### BRIEF DESCRIPTION OF THE DRAWINGS

FIG. 1 is a perspective view of one embodiment of the invention showing a housing holding a writing utensil as may be manipulated for scribbling or the like by holding the housing;

FIG. 2 is a cross-section along line 2-2 of FIG. 1 showing an internal sleeve for holding a writing utensil to provide a sliding motion against a tactile switch when the writing surface is contacted, and showing internal circuitry including a microcontroller, speaker, battery, multi-axis accelerometers, audio amplifier, and LEDs for implementing the present invention;

FIG. 3 is a simplified schematic showing the principal circuit components of the present invention shown in FIG. 2; and

FIG. 4 is a flow chart showing the operation of the program of the microcontroller.

### DETAILED DESCRIPTION OF THE PREFERRED EMBODIMENT

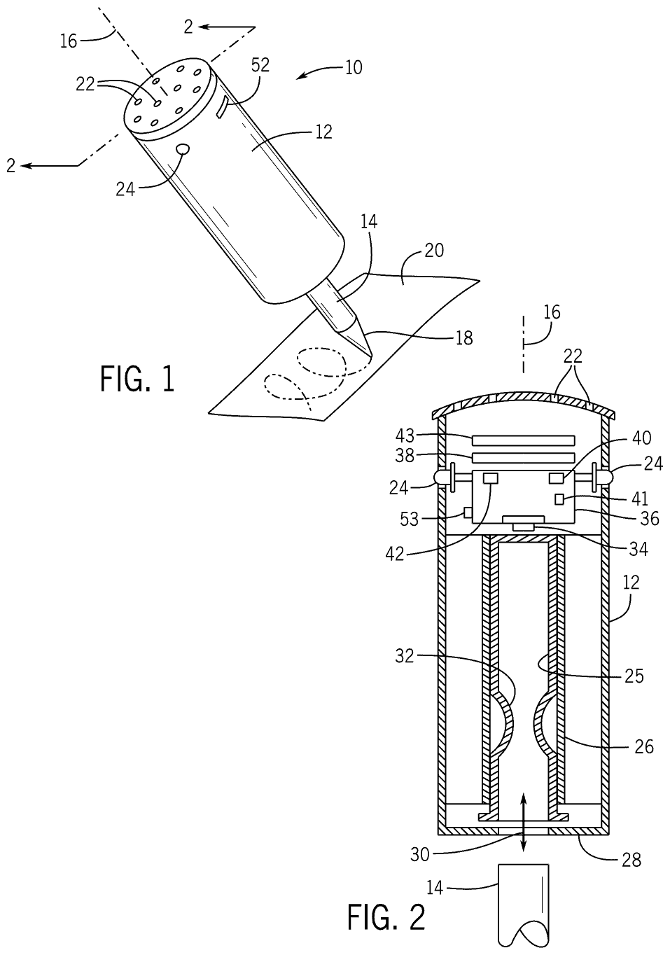

Referring now to FIG. 1, a training tool for pre-writing 10 may include a generally cylindrical housing 12 having a diameter size to be grasped by a young child in the manner of a pencil or the like and desirably having a diameter less than 1.5 inches. A writing utensil 14, such as a felt tip marker having a diameter approximately ½ inch, may be inserted along an axis 16 of the housing 12 being a center axis of the cylindrical form of the housing 12. As so inserted, the proximal end of the writing utensil 14 is retained within the housing 12 and the distal end of the writing utensil 14 extends outside and beyond the distal end of the housing 12. As so exposed, the writing tip 18 of the writing utensil 14 may contact a writing surface 20 during drawing.

A proximal end of the housing 12 may provide for a set of openings 22 allowing sound from an internal speaker to exit out through the housing 12. Similarly, light emitting diodes (LED) 24 associated with internal circuitry may be exposed through openings or windows in the cylindrical sidewalls of the proximal end of the housing 12.

Referring also to FIG. 2, a utensil gripping sleeve 25 may be positioned coaxially within the housing 12 and retained by side guide channels 26 and a distal end plate 28 to permit a constrained and axially confined sliding motion 30 of the utensil gripping sleeve 25 within the housing 12. The utensil gripping sleeve 25 and guide channels 26 may be noncircular in cross-section (for example, triangular) to prevent relative rotation therebetween. The utensil gripping sleeve 25 may, for example, have flexible or spring biased, inwardly extending fingers 32 providing frictional engagement with the writing utensil 14 when inserted therein. Other clamping methods may also be used.

A proximal end of the utensil gripping sleeve 25 may abut the operator of a tactile electric pushbutton switch 34 having a spring biased plunger that may be depressed by proximal movement of the utensil gripping sleeve 25 caused by a pressing of the writing tip 18 of the writing utensil 14 against the writing surface 20. A signal from this electric pushbutton switch 34 may activate the analysis of motion of the housing 12 as will be discussed below.

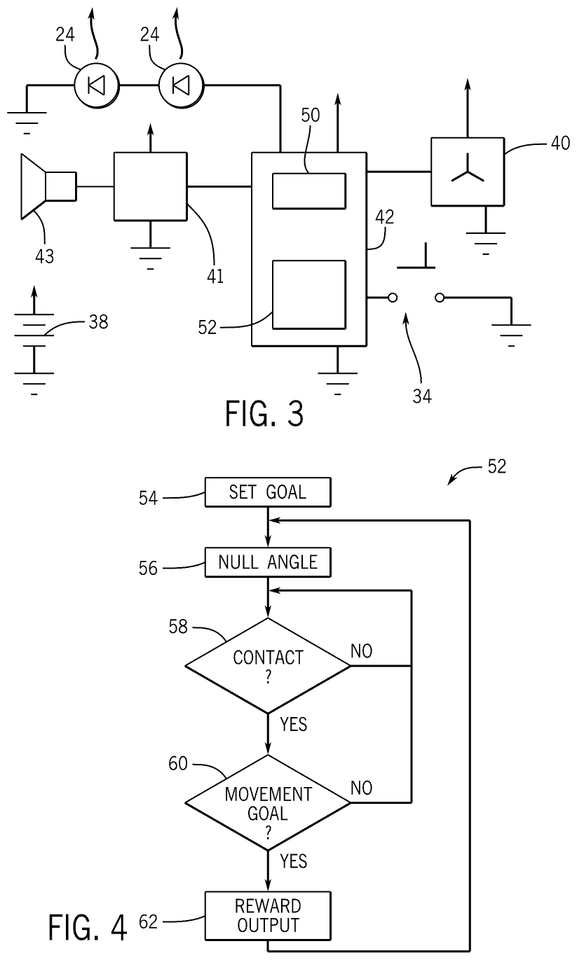

Referring now also to FIG. 3, the electric pushbutton switch 34 may be supported on a printed circuit board 36 or the like also holding an accelerometer 40, an audio amplifier 41, and the LEDs 24, all which communicate electrically with a microcontroller 42. A contained battery 38 provides power to this circuitry which may also communicate with a speaker 43, for example, a piezoelectric type speaker.

The microcontroller 42 may include internal processing circuitry 50 and a stored program 52 executed by the processing circuitry 50. The stored program may be loaded or modified by means of a programming port 53 exposed through the side wall of the housing 12, for example, a micro USB connector, allowing connection of the training tool for pre-writing 10 to an external computer or the like as well as a power connection for recharging the battery 38 through appropriate charging circuitry (not shown).

Referring now to FIG. 4, the program 52 may begin by identifying a goal, for example, such as may be set by an external computer, indicating the type of training to be performed as indicated by process block 54. At succeeding process block 56, the accelerometer 40 may be interrogated to determine long-term average values of acceleration factors indicating gravitational acceleration and hence tipping of the housing 12 to null those effects. Excessive tipping can also be detected to disable the reward system if the training tool for pre-writing 10 is not being used properly (for example writing on a wall or with the tip upward etc.) At decision box 58, a contact with the writing surface 20 may be detected by means of the pushbutton switch 34 triggering an analysis per decision block 60 of that movement and a determination of whether that movement satisfies the goal setting process block 54. If the goal has been satisfied, at process blocks 62 a reward output is provided comprising a flashing of the LEDs 24 and tones or music played through the speaker 43, for example, from a prestored file.

The movement goal of process block 54 may be selected from a variety of different options, typically requiring contact indicated by the pushbutton switch 34 to prevent triggering of the movement goal by simple shaking of the device. In one goal, contact with the writing surface 20 must be detected for a predetermined time with a variety of different acceleration motions perpendicular to the axis 16 (planar) detected such as would suggest scribbling. Axial acceleration may also be detected during this time to indicate paper contact (through lack of significant axial acceleration) even with some intermittency in the activation of the pushbutton switch 34. In another embodiment, phased accelerations in that perpendicular plane are detected to indicate a looping scribble. Particular letters or shapes (for example, straight lines, triangles, etc.) may also be detected for some goals based on these accelerations.

In one embodiment, the analysis of decision block 60 may be performed by a trained machine learning system in which the necessary accelerations are determined from the training set collected from individuals performing the desired pre-writing motions. The machine learning may also accomplish the nulling of process block 56. In one example, the machine learning system may use the Edge Impulse software commercially available from Edge Impulse Inc. of San Jose, California, USA, executed using an Arduino microcontroller as the microcontroller 42. In some embodiments, the accelerometer 40 may be placed lower in the housing (closer to the distal end) for more sensitivity. Additional inputs can be obtained, for example, through the use of a gyroscopic measurement coupled from the accelerometer 40.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microcontroller” and “a processor” or “the microcontroller” and “the processor,” can be understood to include one or more microcontrollers that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

What we claim is:

1. A pre-writing training aid comprising:
a housing adapted to hold a writing utensil extending along an axis with a writing tip of the writing utensil exposed for writing;
a set of sensors for detecting motion of the writing tip on a writing surface in at least two dimensions;
a user feedback output selected from at least one of a speaker and a lamp; and
a sensor circuit for activating the user feedback output to provide positive reinforcement when motion detected by the sensors matches a predefined motion goal.

2. The pre-writing training aid of claim 1 wherein the sensors include orthogonally mounted accelerometers indicating motion of the writing utensil perpendicular to the axis and at least one writing tip pressure sensor indicating an axial pressure on the writing utensil.

3. The pre-writing training aid of claim 2 wherein the sensor circuit compensates for gravitational acceleration caused by a non-vertical extension of the writing utensil during writing.

4. The pre-writing training aid of claim 1 wherein the predefined motion goal is any motion in two dimensions.

5. The pre-writing training aid of claim 1 wherein the predefined motion goal is loops.

6. The pre-writing training aid of claim 1 wherein the predefined motion goal is constant motion along a line.

7. The pre-writing training aid of claim 1 further including a clamp for releasably holding the relaying utensil.

8. The pre-writing training aid of claim 1 wherein an outer surface of the housing is sized to be gripped by a user of the writing utensil during writing.

9. The pre-writing training aid of claim 1 wherein the sensor circuit activity activates the user feedback output to play music to provide positive reinforcement.
